(19) United States
(12) Patent Application Publication
(10) Pub. No.: US 2025/0383679 A1
(43) Pub. Date: Dec. 18, 2025

(54) DUAL-MODE LOW-DROPOUT (LDO)-BASED POWER SUPPLY CIRCUIT

(71) Applicant: QUALCOMM Incorporated, San Diego, CA (US)

(72) Inventor: Hua GUAN, San Diego, CA (US)

(21) Appl. No.: 18/742,885

(22) Filed: Jun. 13, 2024

(51) Int. Cl. G05F 1/575; G05F 1/565; H05B 45/395

(52) U.S. Cl. CPC G05F 1/575; G05F 1/565; H05B 45/395

(57) ABSTRACT

Techniques and apparatus for supplying power via selective voltage or current regulation are provided. An example power supply circuit generally includes a first transistor, a first amplifier including an output coupled to a gate of the first transistor and a first input coupled to a reference node, a current sensing circuit including an input coupled to the gate of the first transistor, and a first multiplexer. The first multiplexer includes a first input coupled to a drain of the first transistor, a second input coupled to an output of the current sensing circuit, and an output coupled to a second input of the first amplifier. Another example power supply circuit generally includes a low-dropout (LDO) regulator circuit, the power supply circuit being selectively configurable as a current regulator or as a voltage regulator with respect to a load for the LDO regulator circuit.

### TECHNICAL FIELD

Certain aspects of the present disclosure generally relate to electronic circuits and, more particularly, to a power supply circuit and techniques for selective voltage or current regulation.

### BACKGROUND

A voltage regulator ideally provides a constant direct current (DC) output voltage regardless of changes in load current or input voltage. Voltage regulators may be classified as either linear regulators or switching regulators. While linear regulators tend to be small and compact, many applications may benefit from the increased efficiency of a switching regulator. A linear regulator may be implemented by a low-dropout (LDO) regulator, for example. A switching regulator (also known as a “switching converter” or “switcher”) may be implemented, for example, by a switched-mode power supply (SMPS), such as a buck converter, a boost converter, a buck-boost converter, or a charge pump.

Power management integrated circuits (power management integrated circuits (ICs) or PMICs) are used for managing the power demands of a host system and may include and/or control one or more voltage regulators (e.g., boost converters). A PMIC may be used in battery-operated devices, such as mobile phones, tablets, laptops, wearables, etc., to control the flow and direction of electrical power in the devices. The PMIC may perform a variety of functions for the device such as DC-to-DC conversion, voltage regulation, battery charging, power-source selection, voltage scaling, power sequencing, etc. For example, a PMIC may feature an LDO regulator for voltage regulation.

### SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description,” one will understand how the features of this disclosure provide the advantages described herein.

Certain aspects of the present disclosure provide a power supply circuit. The power supply circuit generally includes a first transistor, a first amplifier including an output coupled to a gate of the first transistor and a first input coupled to a reference node, a current sensing circuit including an input coupled to the gate of the first transistor, and a first multiplexer. The first multiplexer includes a first input coupled to a drain of the first transistor, a second input coupled to an output of the current sensing circuit, and an output coupled to a second input of the first amplifier.

Certain aspects of the present disclosure provide a power supply circuit. The power supply circuit generally includes a low-dropout (LDO) regulator circuit and is generally selectively configurable as a current regulator or as a voltage regulator with respect to a load for the LDO regulator circuit.

Certain aspects of the present disclosure are directed to a method of supplying power. The method generally includes: (i) generating a representative version of a current flowing through a pass transistor of an LDO regulator circuit; (ii) selecting to feed back the representative version of the current to an amplifier as current feedback or to feed back a voltage from a drain of the pass transistor to the amplifier as voltage feedback; and (iii) driving, with the amplifier, a gate of the pass transistor of the LDO regulator circuit based on the selected current or voltage feedback.

Certain aspects of the present disclosure provide a power supply circuit capable of being used as a camera flash driver or as a low-dropout (LDO) regulator.

Certain aspects of the present disclosure provide a wireless device including the power supply circuit described herein.

Certain aspects of the present disclosure provide a wearable device including the power supply circuit described herein.

Certain aspects of the present disclosure provide an Internet of Things (IoT) device including the power supply circuit described herein.

Certain aspects of the present disclosure provide an integrated circuit (IC) including the power supply circuit (or at least a portion of the power supply circuit) described herein.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram of an example device that includes a selective voltage or current regulator, in which aspects of the present disclosure may be implemented.

FIG. 2 is a block diagram of an example dual-mode low-dropout (LDO)-based power supply circuit, in accordance with certain aspects of the present disclosure.

FIGS. 3A and 3B are circuit diagrams of example dual-mode LDO-based power supply circuits, in accordance with certain aspects of the present disclosure.

FIG. 4 is a flow diagram illustrating example operations for supplying power, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure provide techniques and apparatus for supplying power using a dual-mode low-dropout (LDO)-based power supply circuit selectively configurable as a current regulator or as a voltage regulator. Such a dual-mode LDO-based power supply circuit may include a linear voltage regulator circuit (e.g., an LDO regulator circuit), a current sensing circuit, and a reference and selection circuit coupled to the LDO regulator circuit and the current sensing circuit. The dual-mode power supply circuit may select as feedback, using the reference and selection circuit, a first input coupled to a pass transistor of the LDO regulator circuit in a voltage regulator configuration or a second input coupled to the current sensing circuit in a current regulator configuration.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

### An Example Device

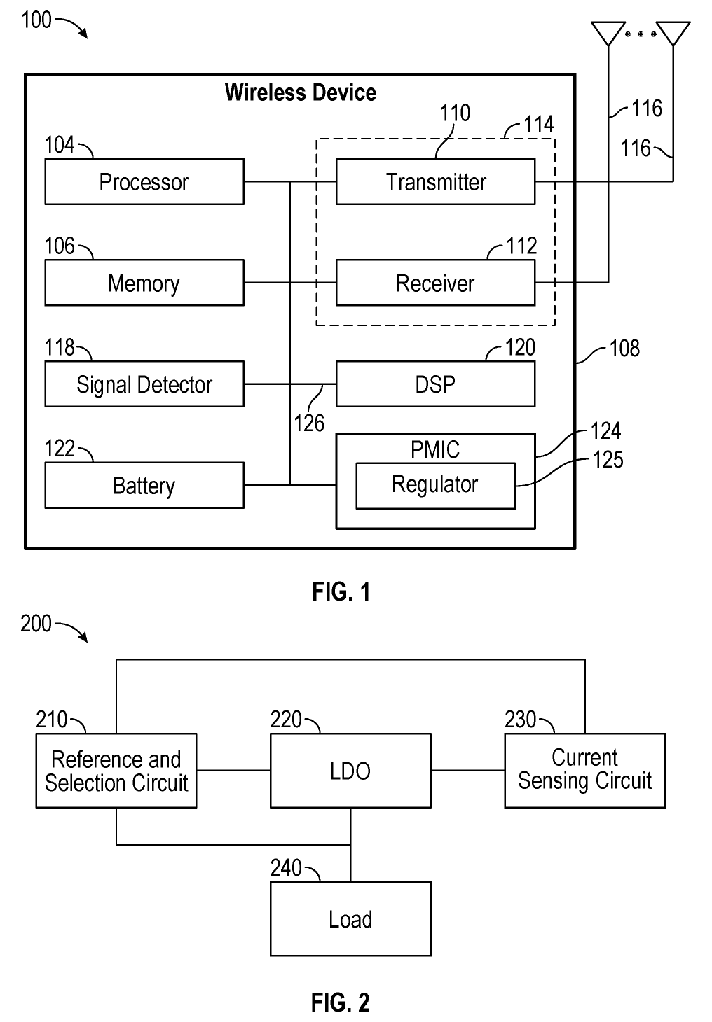

FIG. 1 illustrates an example device 100, in which aspects of the present disclosure may be implemented. The device 100 may be a battery-operated device such as a cellular phone, a personal digital assistant (PDA), a handheld device, a wireless modem, a smartphone, a tablet, a laptop computer, a personal computer, a wearable device, an Internet of Things (IoT) device, an augmented reality device, etc. The device 100 is an example of a device that may be configured to implement the various systems and methods described herein.

The device 100 may include a processor 104 which controls operation of the device 100. The processor 104 may also be referred to as a central processing unit (CPU). Memory 106, which may include both read-only memory (ROM) and random access memory (RAM), provides instructions and data to the processor 104. A portion of the memory 106 may also include non-volatile random access memory (NVRAM). The processor 104 typically performs logical and arithmetic operations based on program instructions stored within the memory 106. The instructions in the memory 106 may be executable to implement the methods described herein.

The device 100 may also include a transmitter 110 and/or a receiver 112 to allow transmission and/or reception, respectively, of data between the device 100 and a remote location. In some cases, the transmitter 110 and receiver 112 may be combined into a transceiver 114. One or more antennas 116 may be attached or otherwise coupled to a housing 108 of the device 100 and electrically coupled to the transceiver 114. For certain aspects, the device 100 may also include multiple transmitters, multiple receivers, and/or multiple transceivers (not shown).

The device 100 may also include a signal detector 118 that may be used in an effort to detect and quantify the level of signals received by the transceiver 114. The signal detector 118 may detect such signals as total energy, energy per subcarrier per symbol, and power spectral density, among others. The device 100 may also include a digital signal processor (DSP) 120 for use in processing signals.

The device 100 may further include a battery 122, which may be used to power the various components of the device 100 (e.g., when another power source—such as a wall adapter or a wireless power charger—is unavailable). The battery 122 illustrated in FIG. 1 may represent multiple portable power sources, such as a main battery and a backup battery (or a supercapacitor). In some cases, the battery 122 may be rechargeable.

The device 100 may also include a power management integrated circuit (IC) (or PMIC) 124 for managing the power from the battery 122 (or batteries), a wall adapter, and/or a wireless power charger to the various components of the device 100. The PMIC 124 may perform a variety of functions for the device such as DC-to-DC conversion, voltage or current regulation (e.g., with a linear regulator 125), battery charging, power-source selection, voltage scaling, power sequencing, etc. In certain aspects, the linear regulator 125 may be implemented with or include a dual-mode LDO-based power supply circuit selectively configurable as a current regulator or as a voltage regulator, as described herein.

The various components of the device 100 may be coupled together by a bus system 126. The bus system 126 may include a power bus, a control signal bus (e.g., system power management interface (SPMI) or inter-integrated circuit (I²C) bus), and/or a status signal bus in addition to a data bus. Additionally or alternatively, various combinations of the components of the device 100 may be coupled together by one or more other suitable techniques.

### Example Dual-Mode LDO-Based Power Supply Circuit

It may be desirable to use a power supply circuit (e.g., a PMIC) versatile enough to supply power in a wide variety of devices in an effort to minimize dark silicon and/or non-recurring engineering (NRE) costs in devices. For example, a power supply circuit may ideally be capable of being used in different types of devices, such as smartphones, wearable devices, IoT devices, and augmented reality devices. Versatile power supply circuits may also be more easily scalable when multiple iterations of a single power supply circuit may be used in a single device or in a single chipset in a device. Furthermore, it is preferable that a power supply circuit include circuitry that may be reusable and/or reconfigurable to provide different functionality, depending on the load powered by the power supply circuit.

In contrast with such versatile circuits, some power supply circuits may include a dedicated flash driver. The dedicated flash driver may only be used as a current regulator (e.g., not providing any voltage regulation capability), may be unable to be repurposed for other functions, and may be large, making the scalability of any power supply circuit with the included dedicated flash driver challenging. In addition, the dedicated flash driver may have complex headroom control (e.g., involving dynamic minimum headroom and maximum headroom) with the associated power supply (e.g., a switched-mode power supply) and, in some cases, may be located on the same chip as the power supply.

In one scenario, a particular power supply circuit design with a dedicated flash driver may be utilized in a smartphone and separately in an augmented reality device. The smartphone may use the dedicated flash driver during operation, but the augmented reality device may not. That is, when the power supply circuit design includes a dedicated flash driver and is included in a smartphone and an augmented reality device, that flash driver may be wasted in the augmented reality device. In another scenario, multiple instances of the same power supply circuit may be utilized in a camera, each power supply circuit including a dedicated flash driver. However, only a single flash driver may be utilized by the camera, meaning that the flash drivers of the other power supply circuits may be of little value and may take up space unnecessarily. In a third scenario, a device may include a power supply circuit with a dedicated flash driver, but may also include a different flash driver separate from the power supply circuit. In this example, the dedicated flash driver in the power supply circuit may be redundant. These types of scenarios result in power supply circuits result in wasted expense and area.

To overcome these challenges, certain aspects of the present disclosure provide techniques and apparatus for supplying power using a dual-mode LDO-based power supply circuit selectively configurable as a current regulator or as a voltage regulator. In this manner, the dual-mode LDO-based power supply circuit may be capable of functioning as a voltage regulator or a current regulator (e.g., a flash driver) depending on the desired functionality, without including a dedicated flash driver. As a result, the dual-mode LDO-based power supply circuit may provide greater flexibility for a wider variety of devices, be easily scalable and configurable, and help to avoid dark silicon while keeping costs down.

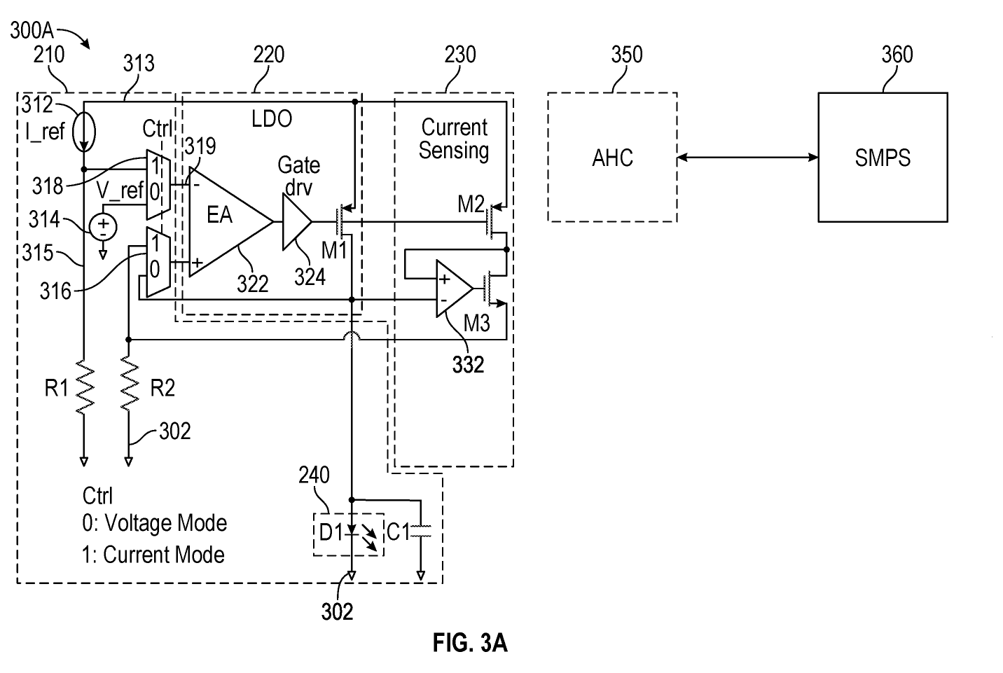

FIG. 2 is a block diagram of an example dual-mode LDO-based power supply circuit 200, in accordance with certain aspects of the present disclosure. The power supply circuit 200 may include a reference and selection circuit 210, an LDO regulator circuit 220, and a current sensing circuit 230. The power supply circuit 200 may be used to supply power to a load 240. The load 240 may represent one or more circuits of a device (e.g., the device 100) that are powered by the power supply circuit 200. In some cases, the load 240 may be a light-emitting diode (LED) for emitting a camera flash, for example.

The LDO regulator circuit 220 may be coupled to the reference and selection circuit 210 and the current sensing circuit 230, and may include an output coupled to the load 240. The reference and selection circuit 210 may receive feedback from the current sensing circuit 230 and from the output of the LDO regulator circuit 220. The power supply circuit 200 (and the LDO regulator circuit 220 therein, using the reference and selection circuit 210 and the current sensing circuit 230) may be selectively configurable as a current regulator or as a voltage regulator, as described herein.

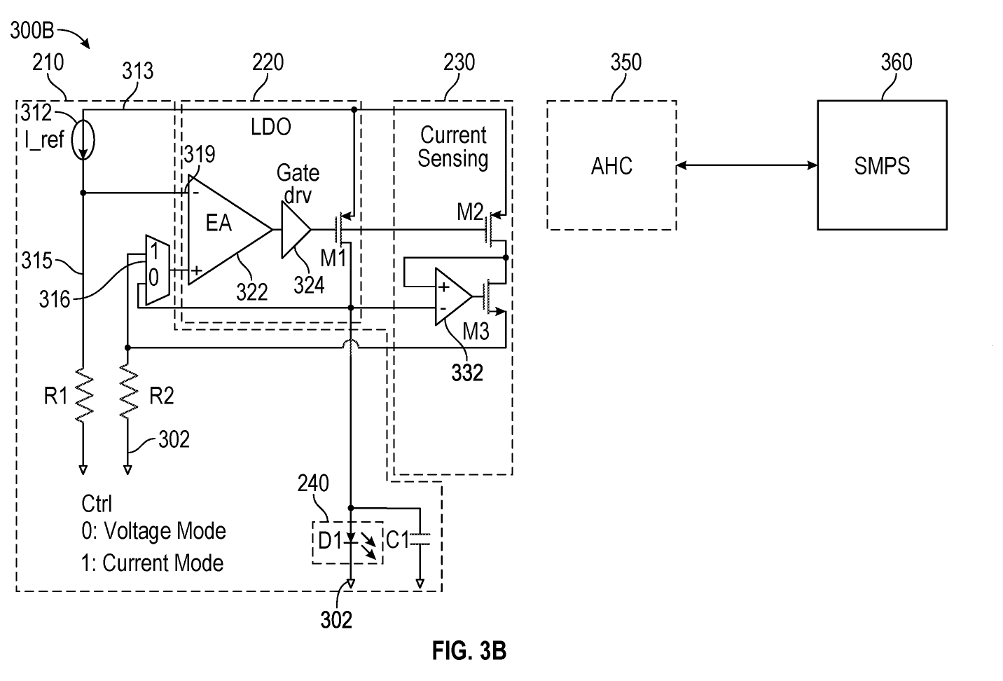

FIG. 3A is a circuit diagram of an example dual-mode LDO-based power supply circuit 300A, in accordance with certain aspects of the present disclosure. The power supply circuit 300A is an example implementation of the power supply circuit 200 and may thus include the reference and selection circuit 210, the LDO regulator circuit 220, and the current sensing circuit 230 for powering the load 240, as illustrated. In certain aspects, the load 240 may be implemented by a light-emitting diode (LED) D1, as illustrated.

The power supply circuit 300A may further include a switched-mode power supply (SMPS) 360 or linear regulator. In a portable device, an input of the SMPS 360 may be coupled to, for example, a battery (e.g., battery 122) of the device (e.g., device 100 of FIG. 1), a wall adapter, and/or a wireless power charger. An output of the SMPS 360 (e.g., having a regulated output voltage) may be coupled to a power supply rail 313 of the power supply circuit 300A. The SMPS 360 may be implemented as a buck converter, a boost converter, a buck-boost converter, or a charge pump, for example. In some cases, the power supply circuit 300A may also include a headroom detector 350 (labeled “AHC,” where “AHC” stands for automatic headroom control), which may be coupled to the output of the SMPS 360, as shown.

The reference and selection circuit 210 may include a reference current source 312, a reference voltage source 314, a first multiplexer 316, a second multiplexer 318, a first resistive element R1, and a second resistive element R2. The first multiplexer 316 may include a first input (labeled “0” and selected when a control input of the first multiplexer 316 is a logical low) coupled to an output of the LDO regulator circuit 220 (e.g., to a drain of a first transistor M1), a second input (labeled “1” and selected when the control input of the first multiplexer 316 is a logical high) coupled to an output of the current sensing circuit 230, and an output coupled to a first input of the LDO regulator circuit 220 (e.g., to a positive input of a first amplifier 322). The second multiplexer 318 may include a first input (labeled “0” and selected when a control input of the second multiplexer 318 is a logical low) coupled to the reference voltage source 314, a second input (labeled “1” and selected when the control input of the second multiplexer 318 is a logical high) coupled to the reference current source 312, and an output coupled to a reference node 319 and a second input of the LDO regulator circuit 220 (e.g., to a negative input of the first amplifier 322).

The reference current source 312 may be coupled between the power supply rail 313 and a reference current node 315. The reference current source 312 may provide a reference current (labeled “I_ref”) sourced by the power supply rail 313. The reference voltage source 314 may be coupled between the first input of the second multiplexer 318 and a reference potential node 302 (e.g., electrical ground) for the power supply circuit 300A. The reference voltage source 314 may have a reference voltage (labeled “V_ref”) and may, for example, be implemented by a bandgap reference. The first resistive element R1 may be coupled between the reference current node 315 and the reference potential node 302. The second resistive element R2 may be coupled between the second input of the first multiplexer 316 and the reference potential node 302. In certain aspects, the first resistive element R1 may be the same type of resistive element as the second resistive element R2. In some cases, the first and second resistive elements R1, R2 may have the same resistance.

The LDO regulator circuit 220 may include the first amplifier 322 (e.g., an error amplifier labeled “EA”) and the first transistor M1 (e.g., a p-type metal-oxide-semiconductor (PMOS) transistor), which functions and may be referred to as the pass transistor of the LDO regulator circuit 220. The first amplifier 322 may include an output coupled to a gate of the first transistor M1, a positive input coupled to an output of the first multiplexer 316, and a negative input coupled to the reference node 319. The reference node 319 may be coupled to an output of the second multiplexer 318, as illustrated. The first transistor M1 may include a source coupled to the power supply rail 313 and a drain coupled to the load 240 (e.g., to an anode of the LED D1).

In certain aspects, a gate driver 324 may be coupled between the first amplifier 322 and the first transistor M1, as illustrated in FIG. 3A. In this case, the gate driver 324 may include an input coupled to the output of the first amplifier 322 and an output coupled to a gate of the first transistor M1.

The current sensing circuit 230 may include a second transistor M2 (e.g., a PMOS transistor), a third transistor M3 (e.g., an n-type metal-oxide-semiconductor (NMOS) transistor), and a second amplifier 332. The second transistor M2 may include a source coupled to the power supply rail 313, a drain coupled to a positive input of the second amplifier 332, and a gate coupled to the gate of the first transistor M1 and the output of the first amplifier 322. The first amplifier 322 may be configured to drive—in some cases, using the gate driver 324—the second transistor M2 and the first transistor M1 using the same voltage. The third transistor M3 may include a drain coupled to the drain of the second transistor M2 and the positive input of the second amplifier 332. The third transistor M3 may also include a source coupled to the second input of the first multiplexer 316 and the second resistive element R2. The second amplifier 332 may include a negative input coupled to the drain of the first transistor M1 (e.g., to the output of the LDO regulator circuit 220) and an output coupled to a gate of the third transistor M3.

The gates of the first transistor M1 and the second transistor M2 may be shorted together, such that their gate voltages are the same, and the sources of the first transistor M1 and the second transistor M2 are shorted together (e.g., via the power supply rail 313). The second amplifier 332 is configured to drive the gate of the third transistor M3 such that the positive input of the second amplifier 332 equals the negative input of the second amplifier 332 (within an offset voltage of the second amplifier 332), and thus, the drains of the first transistor M1 and the second transistor M2 are also (or at least nearly) the same.

The first transistor M1 and the second transistor M2 may be the same transistor type (e.g., with the same threshold voltage (Vₜ)), and the size ratio between the first transistor M1 and the second transistor M2 may be N:1. Thus, the current sensing circuit 230 may be configured to effectively sense the current flowing through the LDO regulator circuit 220 (e.g., through the pass transistor M1) and, due to the N:1 size ratio, cause a fraction of the sensed current to flow through the second transistor M2, in the same direction as the current flowing through the first transistor M1, thereby generating a representative version of the sensed current flowing through the first transistor M1 at the output of the current sensing circuit 230 (which is coupled to the second input of the first multiplexer 316). N may be a number (e.g., an integer) equal to or larger than 1. For example, N may be 100, such that the current passing through the second transistor M2 is approximately equal to one one-hundredth of the current passing through the first transistor M1.

The first multiplexer 316 may be controlled using a control signal labeled “Ctrl”—which may be provided by, for example, a controller included in a PMIC that includes the power supply circuit 300A—to select the first input of the first multiplexer 316 in a voltage regulator configuration for the power supply circuit 300A (e.g., feed back a voltage from the drain of the first transistor M1 to the first amplifier 322 as voltage feedback to the first amplifier 322) or to select the second input of the first multiplexer 316 in a current regulator configuration for the power supply circuit 300A (e.g., feed back the representative version of the current output from the current sensing circuit 230 as current feedback), depending on the desired functionality. As current feedback, the representative version of the current output from the current sensing circuit 230 may flow from the power supply rail 313 to the reference potential node 302 via the second resistive element R2, thereby generating a voltage across the second resistive element R2 (equal to the representative version of the current multiplied by the resistance of the second resistive element R2). This voltage (based on the current output from the current sensing circuit 230) may be fed back to the first amplifier 322 for regulating the current through the first transistor M1.

The second multiplexer 318 may be controlled (e.g., using the control signal Ctrl) to select the first input of the second multiplexer 318 in the voltage regulator configuration for the power supply circuit 300A (e.g., utilizing the voltage V_ref provided by the reference voltage source 314 as the reference voltage for the first amplifier 322) or to select the second input of the second multiplexer 318 in the current regulator configuration for the power supply circuit 300A (e.g., utilizing the voltage at the reference current node 315 as the reference for the first amplifier 322), depending on the desired functionality. The reference current I_ref may flow from the power supply rail 313 to the reference potential node 302 via the first resistive element R1, thereby generating another reference voltage at the reference current node 315 (equal to the current I_ref multiplied by the resistance of the first resistive element R1). In this manner, the other reference voltage is based on the reference current I_ref provided by the reference current source 312.

Controlling the first multiplexer 316 and the second multiplexer 318 may select between the gate of the first transistor M1 being driven by the first amplifier 322 (in some cases using the gate driver 324) based on: (i) the selected first inputs of the first multiplexer 316 and the second multiplexer 318 (e.g., using the voltage feedback from the first transistor M1 and the reference voltage from the reference voltage source 314) or (ii) the selected second inputs of the first multiplexer 316 and the second multiplexer 318 (e.g., using the current feedback from the current sensing circuit 230 and the reference current from the reference current source 312), to provide regulated power to the load 240.

During operation of the power supply circuit 300A (and the LDO regulator circuit 220) as a voltage regulator (e.g., when the first input of the first multiplexer 316 and the first input of the second multiplexer 318 are selected), the first amplifier 322 may drive the first transistor M1 to keep the positive input (e.g., the voltage from the drain of the first transistor M1) of the first amplifier 322 equivalent to the negative input (e.g., the voltage V_ref provided by the reference voltage source 314) of the first amplifier 322 (within an offset voltage of the first amplifier 322). In this manner, the output voltage of the LDO regulator circuit 220 is regulated, such that the power supply circuit 300A may function as a voltage regulator. For example, the power supply circuit 300A may be used as an LDO regulator for the load 240.

During operation of the power supply circuit 300A (and the LDO regulator circuit 220) as a current regulator (e.g., when the second input of the first multiplexer 316 and the second input of the second multiplexer 318 are selected), the current from the current sensing circuit 230 may effectively flow through the second resistive element R2 to the reference potential node 302, which effectively functions as current feedback for the LDO regulator circuit 220. Thus, the first amplifier 322 may drive the first transistor M1 to keep the positive input (e.g., the voltage across resistive element R2) of the first amplifier 322 equivalent to the negative input (e.g., the other reference voltage provided by the reference current I_ref flowing across resistive element R1) of the first amplifier 322 (within an offset voltage of the first amplifier 322). In this manner, the output current of the LDO regulator circuit 220 is regulated, such that the power supply circuit 300A may function as a current regulator for the load 240. For example, the power supply circuit 300A may be used as a camera flash driver, regulating current to the LED D1.

The headroom detector 350 may be coupled to the SMPS 360 (locally or through a communication bus, such as an SPMI), and may provide headroom control for the power supply circuit 300A when operating as a voltage regulator and/or a current regulator. In certain aspects, the power supply circuit 300A may be located on a different chip or on the same chip as the headroom detector 350 and/or SMPS 360.

FIG. 3B is a circuit diagram of an example dual-mode LDO-based power supply circuit 300B, in accordance with certain aspects of the present disclosure. The power supply circuit 300B is similar to the power supply circuit 300A, but may not include the second multiplexer 318 and the reference voltage source 314, as illustrated. In this manner, the reference current node 315 may be the same as the reference node 319, and therefore the reference current node 315 may serve as the negative input for the first amplifier 322 during operation of the dual-mode LDO-based power supply circuit 300B.

### Example Operations for Supplying Power

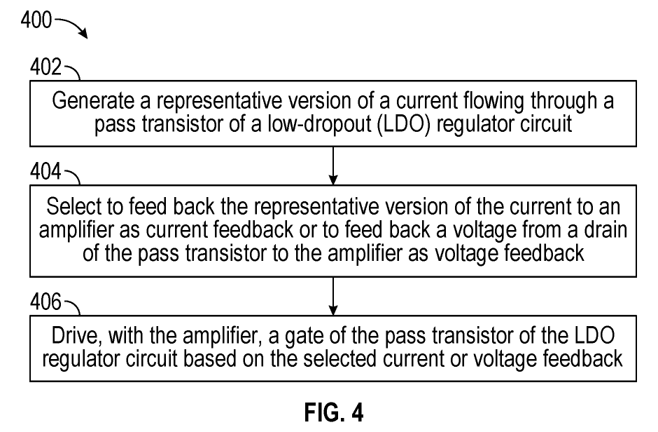

FIG. 4 is a flow diagram illustrating example operations 400 for supplying power, in accordance with certain aspects of the present disclosure. The operations 400 may be performed, for example, by a power supply circuit (e.g., the dual-mode LDO-based power supply circuit 300A of FIG. 3A or the dual-mode LDO-based power supply circuit 300B of FIG. 3B).

The operations 400 may include, at block 402, the power supply circuit generating a representative version of a current flowing through a pass transistor (e.g., transistor M1) of an LDO regulator circuit (e.g., LDO regulator circuit 220). At block 404, the power supply circuit may select to feed back the representative version of the current to an amplifier (e.g., first amplifier 322) as current feedback or to feed back a voltage from a drain of the pass transistor to the amplifier as voltage feedback. At block 406, the amplifier may drive a gate of the pass transistor of the LDO regulator circuit based on the selected current or voltage feedback.

According to certain aspects, generating the representative version of the current flowing through the pass transistor at block 402 may include driving, with the amplifier, a gate of another transistor (e.g., transistor M2). In some cases, the other transistor may be a same transistor type as the pass transistor to generate the representative version of the current.

In certain aspects, the selecting at block 404 may involve controlling a first multiplexer (e.g., first multiplexer 316) that includes a first input receiving the voltage feedback and a second input receiving the current feedback. In certain aspects, the selecting may further include controlling a second multiplexer (e.g., second multiplexer 318) that includes a first input coupled to a reference voltage source (e.g., reference voltage source 314) and a second input coupled to a reference current source (e.g., reference current source 312).

According to certain aspects, the operations 400 may further include the power supply circuit powering a device with the current flowing through the pass transistor. In this case, the selecting at block 404 may involve selecting to feed back the representative version of the current to the amplifier as the current feedback. In certain aspects, the device includes a light-emitting diode (e.g., LED D1).

### Example Aspects

In addition to the various aspects described above, specific combinations of aspects are within the scope of the disclosure, some of which are detailed below:

Aspect 1: A power supply circuit comprising: a first transistor; a first amplifier including an output coupled to a gate of the first transistor and a first input coupled to a reference node; a current sensing circuit including an input coupled to the gate of the first transistor; and a first multiplexer including a first input coupled to a drain of the first transistor, a second input coupled to an output of the current sensing circuit, and an output coupled to a second input of the first amplifier.

Aspect 2: The power supply circuit of Aspect 1, wherein the first multiplexer is configured to: select the first input of the first multiplexer in a voltage regulator configuration for the power supply circuit; and select the second input of the first multiplexer in a current regulator configuration for the power supply circuit.

Aspect 3: The power supply circuit of Aspect 1 or 2, further comprising: a power supply rail coupled to a source of the first transistor; a reference current source coupled between the power supply rail and a reference current node; a first resistive element coupled between the reference current node and a reference potential node; and a second resistive element coupled between the second input of the first multiplexer and the reference potential node.

Aspect 4: The power supply circuit of Aspect 3, further comprising a second multiplexer including a first input coupled to a reference voltage source, a second input coupled to the reference current node, and an output coupled to the reference node.

Aspect 5: The power supply circuit according to any of Aspects 1–4, further comprising a second multiplexer including a first input coupled to a reference voltage source, a second input coupled to a reference current source, and an output coupled to the first input of the first amplifier.

Aspect 6: The power supply circuit according to any of Aspects 1–5, wherein the current sensing circuit comprises: a second transistor; a third transistor including a drain coupled to the drain of the second transistor and a source coupled to the second input of the first multiplexer; and a second amplifier including a first input coupled to the drain of the third transistor, a second input coupled to the drain of the first transistor, and an output coupled to a gate of the third transistor.

Aspect 7: The power supply circuit according to any of Aspects 1–6, further comprising a gate driver including an input coupled to the output of the first amplifier and an output coupled to the gate of the first transistor.

Aspect 8: An apparatus comprising the power supply circuit according to any of Aspects 1–7, the apparatus further comprising a light-emitting diode (LED) including an anode coupled to the drain of the first transistor.

Aspect 9: A power supply circuit comprising a low-dropout (LDO) regulator circuit, the power supply circuit being selectively configurable as a current regulator or as a voltage regulator with respect to a load for the LDO regulator circuit.

Aspect 10: The power supply circuit of Aspect 9, further comprising: a current sensing circuit including an input coupled to a control node of the LDO regulator circuit, a first input of the LDO regulator circuit being coupled to a reference node; and a first multiplexer including a first input coupled to an output of the LDO regulator circuit, a second input coupled to an output of the current sensing circuit, and an output coupled to a second input of the LDO regulator circuit.

Aspect 11: The power supply circuit of Aspect 10, wherein the first multiplexer is configured to: select the first input of the first multiplexer to configure the power supply circuit as the voltage regulator; and select the second input of the first multiplexer to configure the power supply circuit as the current regulator.

Aspect 12: The power supply circuit of Aspect 10 or 11, further comprising: a reference voltage source; a reference current source; and a second multiplexer including a first input coupled to the reference voltage source, a second input coupled to the reference current source, and an output coupled to the reference node.

Aspect 13: A method of supplying power, the method comprising: generating a representative version of a current flowing through a pass transistor of a low-dropout (LDO) regulator circuit; selecting to feed back the representative version of the current to an amplifier as current feedback or to feed back a voltage from a drain of the pass transistor to the amplifier as voltage feedback; and driving, with the amplifier, a gate of the pass transistor of the LDO regulator circuit based on the selected current or voltage feedback.

Aspect 14: The method of Aspect 13, further comprising powering a device with the current flowing through the pass transistor, wherein the selecting comprises selecting to feed back the representative version of the current to the amplifier as the current feedback.

Aspect 15: The method of Aspect 14, wherein the device comprises a light-emitting diode (LED).

Aspect 16: The method according to any of Aspects 13–15, wherein generating the representative version of the current flowing through the pass transistor comprises driving, with the amplifier, a gate of another transistor, the other transistor being a same transistor type as the pass transistor to generate the representative version of the current.

Aspect 17: The method according to any of Aspects 13–16, wherein the selecting comprises controlling a first multiplexer including a first input receiving the voltage feedback and a second input receiving the current feedback.

Aspect 18: The method of Aspect 17, wherein the selecting further comprises controlling a second multiplexer including a first input coupled to a reference voltage source and a second input coupled to a reference current source.

Aspect 19: A power supply circuit capable of being used as a camera flash driver or as a low-dropout (LDO) regulator.

### Additional Considerations

The various operations of methods described above may be performed by any suitable means capable of performing the corresponding functions. The means may include various hardware and/or software component(s) and/or module(s), including, but not limited to a circuit, an application-specific integrated circuit (ASIC), or a processor. Generally, where there are operations illustrated in figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c,and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A power supply circuit comprising:
a first transistor;
a first amplifier including an output coupled to a gate of the first transistor and a first input coupled to a reference node;
a current sensing circuit including an input coupled to the gate of the first transistor; and
a first multiplexer including a first input coupled to a drain of the first transistor, a second input coupled to an output of the current sensing circuit, and an output coupled to a second input of the first amplifier.

2. The power supply circuit of claim 1, wherein the first multiplexer is configured to:
select the first input of the first multiplexer in a voltage regulator configuration for the power supply circuit; and
select the second input of the first multiplexer in a current regulator configuration for the power supply circuit.

3. The power supply circuit of claim 1, further comprising:
a power supply rail coupled to a source of the first transistor;
a reference current source coupled between the power supply rail and a reference current node;
a first resistive element coupled between the reference current node and a reference potential node; and
a second resistive element coupled between the second input of the first multiplexer and the reference potential node.

4. The power supply circuit of claim 3, further comprising a second multiplexer including a first input coupled to a reference voltage source, a second input coupled to the reference current node, and an output coupled to the reference node.

5. The power supply circuit of claim 1, further comprising a second multiplexer including a first input coupled to a reference voltage source, a second input coupled to a reference current source, and an output coupled to the first input of the first amplifier.

6. The power supply circuit of claim 1, wherein the current sensing circuit comprises:
a second transistor;
a third transistor including a drain coupled to the drain of the second transistor and a source coupled to the second input of the first multiplexer; and
a second amplifier including a first input coupled to the drain of the third transistor, a second input coupled to the drain of the first transistor, and an output coupled to a gate of the third transistor.

7. The power supply circuit of claim 1, further comprising a gate driver including an input coupled to the output of the first amplifier and an output coupled to the gate of the first transistor.

8. An apparatus comprising the power supply circuit of claim 1, the apparatus further comprising a light-emitting diode (LED) including an anode coupled to the drain of the first transistor.

9. A power supply circuit comprising a low-dropout (LDO) regulator circuit, the power supply circuit being selectively configurable as a current regulator or as a voltage regulator with respect to a load for the LDO regulator circuit.

10. The power supply circuit of claim 9, further comprising:
a current sensing circuit including an input coupled to a control node of the LDO regulator circuit, a first input of the LDO regulator circuit being coupled to a reference node; and
a first multiplexer including a first input coupled to an output of the LDO regulator circuit, a second input coupled to an output of the current sensing circuit, and an output coupled to a second input of the LDO regulator circuit.

11. The power supply circuit of claim 10, wherein the first multiplexer is configured to:
select the first input of the first multiplexer to configure the power supply circuit as the voltage regulator; and
select the second input of the first multiplexer to configure the power supply circuit as the current regulator.

12. The power supply circuit of claim 10, further comprising:
a reference voltage source;
a reference current source; and
a second multiplexer including a first input coupled to the reference voltage source, a second input coupled to the reference current source, and an output coupled to the reference node.

13. A method of supplying power, the method comprising:
generating a representative version of a current flowing through a pass transistor of a low-dropout (LDO) regulator circuit;
selecting to feed back the representative version of the current to an amplifier as current feedback or to feed back a voltage from a drain of the pass transistor to the amplifier as voltage feedback; and
driving, with the amplifier, a gate of the pass transistor of the LDO regulator circuit based on the selected current or voltage feedback.

14. The method of claim 13, further comprising powering a device with the current flowing through the pass transistor, wherein the selecting comprises selecting to feed back the representative version of the current to the amplifier as the current feedback.

15. The method of claim 14, wherein the device comprises a light-emitting diode (LED).

16. The method of claim 13, wherein generating the representative version of the current flowing through the pass transistor comprises driving, with the amplifier, a gate of another transistor, the other transistor being a same transistor type as the pass transistor to generate the representative version of the current.

17. The method of claim 13, wherein the selecting comprises controlling a first multiplexer including a first input receiving the voltage feedback and a second input receiving the current feedback.

18. The method of claim 17, wherein the selecting further comprises controlling a second multiplexer including a first input coupled to a reference voltage source and a second input coupled to a reference current source.
